(19) United States
(12) Patent Application Publication
(10) Pub. No.: US 2026/0107319 A1
(43) Pub. Date: Apr. 16, 2026

(54) METHOD AND APPARATUS FOR COMMON CHANNEL TRANSMISSION HANDLING FOR NETWORK ENERGY SAVING IN WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Sangkyu BAEK, Suwon-si (KR)

(21) Appl. No.: 19/116,728

(22) PCT Filed: Oct. 12, 2023
(86) PCT No.: PCT/KR2023/015714

§ 371 Date: Mar. 28, 2025

(30) Foreign Application Priority Data
Oct. 26, 2022 (KR) 10-2022-0139403

(51) Int. Cl. H04W 74/0833; H04W 52/02; H04W 68/02

(52) U.S. Cl. CPC H04W 74/0833; H04W 52/02; H04W 68/02

(57) ABSTRACT

The disclosure relates to a 5G or 6G communication system for supporting a higher data transmission rate. Specifically, the present disclosure provides method and apparatus for common channel transmission handling or avoiding for network energy saving in wireless (mobile) communication system.

### TECHNICAL FIELD

The disclosure relates to a wireless communication system (or a mobile communication system). Specifically, the disclosure relates to an apparatus, a method and a system for handling (or, avoiding) common channel transmission for network energy saving (NES) in wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface achitecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Recently, there are needs to enhance network energy saving scheme in accordance with development of communication system.

### Solution to Problem

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, on a first cell of a first frequency, redirect information associated with a second cell of a second frequency; and performing a random access procedure on the second cell of the second frequency based on the redirect information.

In accordance with another aspect of the disclosure, a terminal is provided. The terminal comprises: a transceiver; and a controller coupled with the transceiver and configured to: receive, on a first cell of a first frequency, redirect information associated with a second cell of a second frequency, and perform a random access procedure on the second cell of the second frequency based on the redirect information.

### Advantageous Effects of Invention

According to various embodiments of the disclosure, transmission of common channel can be handled (or avoided), thereby network energy saving procedure can be efficiently accomplished.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example of a random access channel (RACH) procedure in accordance with an embodiment of the disclosure.

FIG. 2 illustrates another example of a RACH procedure in accordance with another embodiment of the disclosure.

FIG. 3 illustrates another example of a RACH procedure in accordance with another embodiment of the disclosure.

FIG. 4 illustrates another example of a RACH procedure in accordance with another embodiment of the disclosure.

FIG. 5 illustrates another example of a RACH procedure in accordance with another embodiment of the disclosure.

FIG. 6 illustrates another example of a RACH procedure in accordance with another embodiment of the disclosure.

FIG. 7 illustrates another example of a RACH procedure in accordance with another embodiment of the disclosure.

FIG. 8 illustrates another example of a RACH procedure in accordance with another embodiment of the disclosure.

FIG. 9 is a block diagram of a terminal according to an embodiment of the disclosure.

FIG. 10 is a block diagram of a base station according to an embodiment of the disclosure.

Throughout the drawings, like reference numerals will be understood to refer to like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or next generation node B (gNB).

The “UE” is an entity communicating with a BS and may be referred to as UE, device, mobile station (MS), mobile equipment (ME), or terminal.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in radio resource control connected (RRC_CONNECTED) is configured to utilize radio resources provided by two distinct schedulers, located in two different nodes connected via a non-ideal backhaul and providing either Evolved Universal Mobile Telecommunication System Terrestrial (UMTS) Radio Access Network) E-UTRA (i.e. if the node is an ng-eNB) or New Radio (NR) access (i.e. if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) (SpCell(s)) and all secondary cells (SCells). In NR the term Master Cell Group (MCG) refers to a group of serving cells associated with the Master Node, comprising of the primary cell (PCell) and optionally one or more SCells. In NR the term Secondary Cell Group (SCG) refers to a group of serving cells associated with the Secondary Node, comprising of the primary SCG cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, SCell is a cell providing additional radio resources on top of Special Cell. Primary SCG Cell refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

System information acquisition in fifth generation wireless communication system: In the fifth generation wireless communication system, node B (gNB) or base station in cell broadcast Synchronization Signal and physical broadcast channel (PBCH) block (SSB) consists of primary synchronization signal (PSS) and secondary synchronization signal (SSS) and system information. System information includes common parameters needed to communicate in cell. In the fifth generation wireless communication system (also referred as next generation radio or NR), System Information (SI) is divided into the master information block (MIB) and a number of system information blocks (SIBs) where:
the MIB is always transmitted on the broadcast channel (BCH) with a periodicity of 80 ms and repetitions made within 80 ms, and it includes parameters that are needed to acquire system information block 1(SIB1) from the cell.
the SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. The scheduling information in SIB 1 includes mapping between SIBs and SI messages, periodicity of each SI message and SI window length. The scheduling information in SIB 1 includes an indicator for each SI message, which indicates whether the concerned SI message is being broadcasted or not. If at least one SI message is not being broadcasted, SIB1 may include random access resources (e.g., physical random access channel (PRACH) preamble(s) and PRACH resource(s)) for requesting gNB to broadcast one or more SI message(s).
SIBs other than SIB1 are carried in SystemInformation (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID.
UE acquires SIB 1 from the camped or serving cell. UE check the BroadcastStatus bit in SIB 1 for SI message which UE needs to acquire. SI request configuration for supplement uplink (SUL) is signaled by gNB using the IE si-RequestConfigSUL in SIB1. If the IE si-RequestConfigSUL is not present in SIB1, UE considers that SI request configuration for SUL is not signaled by gNB. SI request configuration for normal uplink (NUL) is signaled by gNB using the IE si-RequestConfig in SIB1. If the IE si-RequestConfig is not present in SIB1, UE considers that SI request configuration for NUL is not signaled by gNB. If SI message which UE needs to acquire is not being broadcasted (i.e., BroadcastStatus bit is set to zero), UE initiates transmission of SI request. The procedure for SI request transmission is as follows:
If SI request configuration is signaled by gNB for SUL, and criteria to select SUL is met (i.e., reference signal received power (RSRP) derived from SSB measurements of camped or serving cell<rsrp-ThresholdSSB-SUL, where rsrp-ThresholdSSB-SUL is signaled by gNB (e.g., in broadcast signaling such as SIB1)): UE initiate transmission of SI request based on Msg1 based SI request on SUL. In other words, UE initiates Random Access procedure using the PRACH preamble(s) and PRACH resource(s) in SI request configuration of SUL. UE transmits Msg1 (i.e., Random access preamble) and waits for acknowledgement for SI request. Random access resources (PRACH preamble(s) and PRACH occasions(s)) indicated in SI request configuration of SUL is used for Msg1. Msg1 is transmitted on SUL. If acknowledgement for SI request is received, UE monitors the SI window of the requested SI message in one or more SI period(s) of that SI message.
Else if SI request configuration is signaled by gNB for NUL and criteria to select NUL is met (i.e., NUL is selected if SUL is supported in camped or serving cell and RSRP derived from SSB measurements of camped or serving cell>=rsrp-ThresholdSSB-SUL; OR NUL is selected if SUL is not supported in serving cell): UE initiate transmission of SI request based on Msg1 based SI request on NUL. In other words, UE initiates Random Access procedure using the PRACH preamble(s) and PRACH resource(s) in SI request configuration of NUL. UE transmits Msg1 (i.e., Random access preamble) and waits for acknowledgement for SI request. Random access resources (PRACH preamble(s) and PRACH occasions(s)) indicated in SI request configuration of NUL is used for Msg1. Msg1 is transmitted on NUL. If acknowledgement for SI request is received, UE monitors the SI window of the requested SI message in one or more SI period(s) of that SI message.

Else, UE initiate transmission of SI request based on Msg3 based SI request. In other words, UE initiate transmission of RRCSystemInfoRequest message. UE transmits Msg1 (i.e., Random access preamble) and waits for random access response. Common random access resources (PRACH preamble(s) and PRACH occasions(s)) are used for Msg1. In the UL grant received in random access response, UE transmits RRCSystemInfoRequest message and waits for acknowledgement for SI request (i.e., RRCSystemInfoRequest message). If acknowledgement for SI request (i.e., RRCSystemInfoRequest message) is received, UE monitors the SI window of the requested SI message in one or more SI period(s) of that SI message. Note that if SUL is configured, UL carrier for Msg1 transmission will be selected by UE in similar manner as selected by UE for Msg1 based SI request. SUL is the selected UL carrier, if RSRP derived from SSB measurements of camped or serving cell <rsrp-ThresholdSSB-SUL where rsrp-ThresholdSSB-SUL is signaled by gNB (e.g. in broadcast signaling such as SIB1). NUL is the selected UL carrier, if RSRP derived from SSB measurements of camped or serving cell>=rsrp-ThresholdSSB-SUL where rsrp-ThresholdSSB-SUL is signaled by gNB (e.g. in broadcast signaling such as SIB1).

Physical downlink control channel (PDCCH) in fifth generation wireless communication system: In the fifth generation wireless communication system, PDCCH is used to schedule downlink (DL) transmissions on physical downlink shared channel (PDSCH) and uplink (UL) transmissions on physical uplink shared channel (PUSCH), where the Downlink Control Information (DCI) on PDCCH includes: Downlink assignments containing at least modulation and coding format, resource allocation, and hybrid automatic repeat request (ARQ) information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and orthogonal frequency division multiplexing (OFDM) symbol(s) where the UE may assume no transmission is intended for the UE; Transmission of transmission power control (TPC) commands for physical uplink control channel (PUCCH) and PUSCH; Transmission of one or more TPC commands for sounding reference signal (SRS) transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations are signaled by GNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

$$( y * ( number of slots in a radio frame ) + x - Monitoring ‐ offset ‐ PDCCH ‐ slot ) mod ( Monitoring ‐ periodicity ‐ PDCCH ‐ slot ) = 0 ; \qquad [ equation ]$$

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations are signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of Transmission configuration indicator (TCI) states. One DL reference signal (RS) ID (SSB or channel state information reference signal (CSI-RS)) is configured per TCI state. The list of TCI states corresponding to a coreset configuration is signaled by gNB via RRC signaling. One of the TCI state in TCI state list is activated and indicated to UE by gNB via medium access control (MAC) control element (CE). TCI state indicates the DL TX beam (DL TX beam is quasi-collocated (QCLed) with SSB/CSI-RS of TCI state) used by GNB for transmission of PDCCH in the PDCCH monitoring occasions of a search space. For PDSCH, TCI state of scheduling PDCCH can be used for scheduled PDSCH. Alternately, TCI state of the PDCCH for the lowest corset ID in the slot is used for PDSCH. Alternately combination of RRC+MAC CE +DCI is used to indicate the TCI state for PDSCH. RRC configures a list of TCI state, MAC CE indicates a subset of these TCI states and DCI indicates one of the TCI state from list of TCI states indicated in MAC CE.

Bandwidth adaptation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e., it does not have to monitor PDCCH on the entire DL frequency of the serving cell. In RRC connected state, UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in fifth generation wireless communication system: In the 5G wireless communication system, random access (RA) is supported. Random access (RA) is used to achieve UL time synchronization. RA is used during initial access, handover, RRC connection re-establishment procedure, scheduling request transmission, SCG addition/modification, beam failure recovery and data or control information transmission in UL by non-synchronized UE in RRC CONNECTED state. Several types of random access procedure is supported.

Contention based random access (CBRA): This is also referred as 4 step CBRA. In this type of random access, UE first transmits Random Access preamble (also referred as Msg1) and then waits for Random access response (RAR) in the RAR window. RAR is also referred as Msg2. Next generation node B (gNB) transmits the RAR on PDSCH. PDCCH scheduling the PDSCH carrying RAR is addressed to RA-radio network temporary identifier (RA-RNTI). RA-RNTI identifies the time-frequency resource (also referred as PRACH occasion or PRACH transmission (TX) occasion or RACH occasion) in which RA preamble was detected by gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier. Several RARs for various Random access preambles detected by gNB can be multiplexed in the same RAR MAC protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by gNB in RACH configuration) number of times, the UE goes back to first step i.e., select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (i.e., cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives a PDCCH addressed to C-RNTI included in Msg3, contention resolution is considered successful, contention resolution timer is stopped and RA procedure is completed. While the contention resolution timer is running, if UE receives contention resolution MAC CE including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step i.e., select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for Scell, etc. Evolved node B (eNB) assigns to UE dedicated Random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to CBRA procedure. CFRA is considered successfully completed after receiving the RAR including RAPID of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access i.e., during random access resource selection for Msg1 transmission UE determines whether to transmit dedicated preamble or non dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e. dedicated preambles/ROs) are provided by gNB, UE select non dedicated preamble. Otherwise, UE select dedicated preamble. So during the RA procedure, one random access attempt can be CFRA while other random access attempt can be CBRA.

2 step contention based random access (2 step CBRA): In the first step, UE transmits random access preamble on PRACH and a payload (i.e., MAC PDU) on PUSCH. The random access preamble and payload transmission is also referred as MsgA. In the second step, after MsgA transmission, the UE monitors for a response from the network (i.e., gNB) within a configured window. The response is also referred as MsgB. GNB transmits the MsgB on PDSCH. PDCCH scheduling the PDSCH carrying MsgB is addressed to MsgB-radio network temporary identifier (MSGB-RNTI). MSGB-RNTI identifies the time-frequency resource (also referred as PRACH occasion or PRACH TX occasion or RACH occasion) in which RA preamble was detected by gNB. The MSGB-RNTI is calculated as follows: RA-RNTI=1+s_id+14*t_id+14*80*f_id+14*80*8*ul_carrier_id+14*80*8*2, where s_id is the index of the first OFDM symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If CCCH SDU was transmitted in MsgA payload, UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (i.e., upon transmitting Msg3), UE retransmits MsgA. If configured window in which UE monitor network response after transmitting MsgA expires and UE has not received MsgB including contention resolution information or fallback information as explained above, UE retransmits MsgA. If the random access procedure is not successfully completed even after transmitting the msgA configurable number of times, UE fallbacks to 4 step RACH procedure i.e. UE only transmits the PRACH preamble.

MsgA payload may include one or more of CCCH SDU, dedicated control channel (DCCH) SDU, dedicated traffic channel (DTCH) SDU, buffer status report (BSR) MAC CE, power headroom report (PHR) MAC CE, SSB information, C-RNTI MAC CE, or padding. MsgA may include UE ID (e.g., random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure. When UE performs RA after power on (before it is attached to the network), then UE ID is the random ID. When UE perform RA in IDLE state after it is attached to network, the UE ID is S-TMSI. If UE has an assigned C-RNTI (e.g., in connected state), the UE ID is C-RNTI. In case UE is in INACTIVE state, UE ID is resume ID. In addition to UE ID, some addition ctrl information can be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case gNB assigns to UE dedicated Random access preamble(s) and PUSCH resource(s) for MsgA transmission. RO(s) to be used for preamble transmission may also be indicated. In the first step, UE transmits random access preamble on PRACH and a payload on PUSCH using the contention free random access resources (i.e., dedicated preamble/PUSCH resource/RO). In the second step, after MsgA transmission, the UE monitors for a response from the network (i.e., gNB) within a configured window. The response is also referred as MsgB.

GNB transmits the MsgB on PDSCH. PDCCH scheduling the PDSCH carrying MsgB is addressed to MSGB-RNTI. MSGB-RNTI identifies the time-frequency resource (also referred as physical PRACH occasion or PRACH TX occasion or RACH occasion) in which RA preamble was detected by gNB. The MSGB-RNTI is calculated as follows: RA-RNTI=1+s_id+14*t_id+14*80*f_id+14*80*8*ul_carrier_id+14*80*8*2, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If UE receives PDCCH addressed to C-RNTI, random access procedure is considered successfully completed. If UE receives fallback information corresponding to its transmitted preamble, random access procedure is considered successfully completed.

For certain events such has handover and beam failure recovery if dedicated preamble(s) and PUSCH resource(s) are assigned to UE, during first step of random access i.e., during random access resource selection for MsgA transmission UE determines whether to transmit dedicated preamble or non dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by gNB, UE select non dedicated preamble. Otherwise, UE select dedicated preamble. So during the RA procedure, one random access attempt can be 2 step CFRA while other random access attempt can be 2 step CBRA.

Upon initiation of random access procedure, UE first selects the carrier (SUL or NUL). If the carrier to use for the Random Access procedure is explicitly signalled by gNB, UE select the signalled carrier for performing Random Access procedure. If the carrier to use for the Random Access procedure is not explicitly signalled by gNB; and if the Serving Cell for the Random Access procedure is configured with supplementary uplink and if the RSRP of the downlink pathloss reference is less than rsrp-ThresholdSSB-SUL: UE select the SUL carrier for performing Random Access procedure. Otherwise, UE select the NUL carrier for performing Random Access procedure. Upon selecting the UL carrier, UE determines the UL and DL BWP for random access procedure as specified in section 5.15 of TS 38.321. UE then determines whether to perform 2 step or 4 step RACH for this random access procedure.
If this random access procedure is initiated by PDCCH order and if the ra-PreambleIndex explicitly provided by PDCCH is not 0b000000, UE selects 4 step RACH.
else if 2 step contention free random access resources are signaled by gNB for this random access procedure, UE selects 2 step RACH.
else if 4 step contention free random access resources are signaled by gNB for this random access procedure, UE selects 4 step RACH.
else if the UL BWP selected for this random access procedure is configured with only 2 step RACH resources, UE selects 2 step RACH.
else if the UL BWP selected for this random access procedure is configured with only 4 step RACH resources, UE selects 4 step RACH.
else if the UL BWP selected for this random access procedure is configured with both 2 step and 4 step RACH resources,
if RSRP of the downlink pathloss reference is below a configured threshold, UE selects 4 step RACH. Otherwise UE selects 2 step RACH.

Paging in fifth generation wireless communication system: In the 5th generation (also referred as NR) wireless communication system UE can be in one of the following RRC state: RRC IDLE, RRC INACTIVE and RRC CONNECTED. The RRC states can further be characterized as follows:
In RRC_IDLE state, a UE specific DRX may be configured by upper layers (i.e., non-access stratum (NAS)). The UE, monitors Short Messages transmitted with paging RNTI (P-RNTI) over DCI; Monitors a Paging channel for CN paging using 5G-S-TMSI;-Performs neighbouring cell measurements and cell (re-)selection; Acquires system information and can send SI request (if configured).
In RRC_INACTIVE state, a UE specific discontinuous reception (DRX) may be configured by upper layers or by RRC layer; In this state, UE stores the UE Inactive access stratum (AS) context. A RAN-based notification area is configured by RRC layer. The UE monitors Short Messages transmitted with P-RNTI over DCI; Monitors a Paging channel for CN paging using 5G-S-TMSI and RAN paging using fullI-RNTI; Performs neighbouring cell measurements and cell (re-) selection; Performs RAN-based notification area updates periodically and when moving outside the configured RAN-based notification area; Acquires system information and can send SI request (if configured).

In the RRC_CONNECTED, the UE stores the AS context. Unicast data is transmitted/received to/from UE. At lower layers, the UE may be configured with a UE specific DRX. The UE, monitors Short Messages transmitted with P-RNTI over DCI, if configured; Monitors control channels associated with the shared data channel to determine if data is scheduled for it; Provides channel quality and feedback information; Performs neighboring cell measurements and measurement reporting; Acquires system information.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the AMF (Access and Mobility Management Function) by means of the NG-C interface and to the UPF (User Plane Function) by means of the NG-U interface. In the 5th generation (also referred as NR) wireless communication system, the UE may use DRX in RRC_IDLE and RRC INACTIVE state in order to reduce power consumption. In the RRC_IDLE/RRC_INACTIVE state UE wake ups at regular intervals (i.e., every DRX cycle) for short periods to receive paging, to receive SI update notification and to receive emergency notifications. Paging message is transmitted using PDSCH. PDCCH is addressed to P-RNTI if there is a paging message in PDSCH. P-RNTI is common for all UEs. UE identity (i.e., S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e., PDCCH is masked with P-RNTI) over data channel (i.e., PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. In RRC connected state, UE can monitor any PO in paging DRX cycle and monitors at least one PO in SI modification period. In the RRC idle/inactive mode UE monitors PO every DRX cycle in its active DL BWP. A PO is a set of ‘S’ PDCCH monitoring occasions for paging, where ‘S’ is the number of transmitted SSBs (i.e. the SSB consists of PSS, SSS and PBCH) in cell. UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE_ID mod N).
Index (i_s), indicating the index of the PO is determined by i_s=floor(UE_ID/N) mod Ns.
T is DRX cycle of the UE.
   In RRC_INACTIVE state, T is determined by the shortest of the UE specific DRX value configured by RRC, UE specific DRX value configured by NAS, and a default DRX value broadcast in system information.
   In RRC_IDLE state, T is determined by the shortest of UE specific DRX value configured by NAS, and a default DRX value broadcast in system information. If UE specific DRX is not configured by upper layers (i.e., NAS), the default value is applied.
N: number of total paging frames in T
Ns: number of paging occasions for a PF
PF_offset: offset used for PF determination
UE_ID: 5G-S-TMSI mod 1024

Parameters Ns, nAndPagingFrameOffset, and the length of default DRX Cycle are signaled in SIB1. The values of N and PF_offset are derived from the parameter nAndPagingFrameOffset. If the UE has no 5G-S-TMSI, for instance when the UE has not yet registered onto the network, the UE shall use as default identity UE_ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceId other than 0 is configured for pagingSearchSpace, the UE monitors the (i_s+1)th PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signalled, the (i_s+1)th PO is a set of ‘S’ consecutive PDCCH monitoring occasions for paging starting from the PDCCH monitoring occasion number indicated by firstPDCCH-MonitoringOccasionOfPO (i.e. the (i_s+1)th value of the firstPDCCH-MonitoringOccasionOfPO parameter). Otherwise, the (i_s+1)th PO is a set of ‘S’ consecutive PDCCH monitoring occasions for paging starting from the (i_s*S)th PDCCH monitoring occasion for paging. ‘S’ is the number of actual transmitted SSBs determined according to parameter ssb-PositionsInBurst signalled in SystemInformationBlock1 received from gNB. The parameter firstPDCCH-MonitoringOccasionOfPO is signalled in SIB1 for paging in initial DL BWP. For paging in a DL BWP other than the initial DL BWP, the parameter firstPDCCH-MonitoringOccasionOfPO is signaled in the corresponding BWP configuration.

Network energy saving (NES) is impacted by periodically transmitted common channels/signals i.e. SSB, MIB and SIB1. There are needs to minimize these transmissions of common channels/signals as much as possible to reduce network energy consumptions.

### Method 1

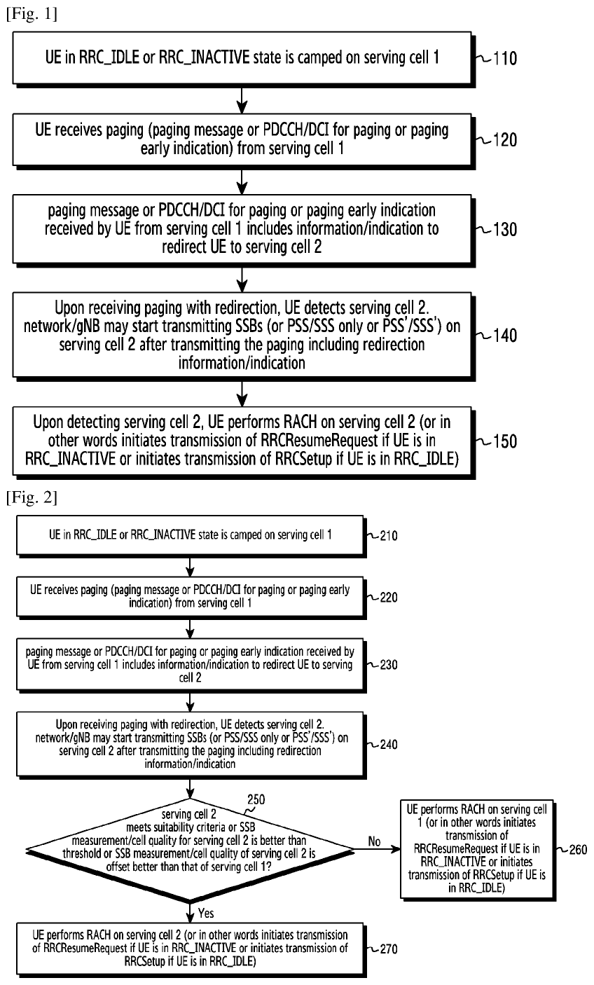

FIG. 1 and FIG. 2 illustrate examples of RACH procedure in accordance with embodiments of the disclosure.

Network comprise of serving cell (e.g., Cell 1) on a first carrier frequency F1 and another serving cell (e.g., Cell 2) on a second carrier frequency F2. Both serving cells are co-located (i.e., either they have same coverage or coverage of serving cell 1 can be larger than coverage of serving cell 2 wherein coverage of serving cell 2 is subset of coverage of serving cell 1).

Serving cell 2 does not broadcast system information. Serving cell 2 does not broadcast paging. Serving cell does not broadcast SSB. Serving cell 1 signals the system information for serving cell 2. Serving cell 1 may transmit one or more SIBs including system information for serving cell 2.

UE in RRC_IDLE or RRC_INACTIVE state is camped on serving cell 1 (110, 210). UE receives paging (e.g., paging message or PDCCH/DCI for paging or paging early indication or low power wakeup signal/indication) from serving cell 1 (120, 220). In an embodiment, paging message or PDCCH/DCI for paging or paging early indication received by UE from serving cell 1 includes information/indication to redirect UE to another cell (e.g., serving cell 2) (130, 230). Information can be physical cell identity (PCI) of cell (e.g., PCI of Cell 2) or global cell identity of Cell 2 or cell index of Cell 2. Redirection information/indication in paging message can be per paging record included in paging message or it can be common for all paging records included in paging message. If Redirection information/indication in paging message is per paging record, UE considers redirection is for itself if it is included in paging record corresponding to UE's identity (5G-S-TMSI or I-RNTI). Redirection information/indication in paging early indication or low power wakeup signal/indication can be per (paging) subgroup or it can be common for all (paging) subgroups. UEs can be associated with different (paging) subgroup. If Redirection information/indication in paging early indication or low power wakeup signal/indication is per (paging) subgroup, UE considers redirection is for itself if it is included in paging early indication or low power wakeup signal/indication corresponding to UE's (paging) subgroup.

Upon receiving paging with redirection, UE detects serving cell 2. In this method, network/gNB may start transmitting SSBs (or PSS/SSS only or PSS′/SSS′) on serving cell 2 after transmitting the paging including redirection information/indication (140, 240). The PSS′/SSS′ can be different synchronization signals than the PSS/SSS.

According to an embodiment of FIG. 1, upon detecting serving cell 2, UE performs RACH on serving cell 2 (or in other words initiates transmission of RRCResumeRequest if UE is in RRC_INACTIVE or initiates transmission of RRCSetup if UE is in RRC_IDLE) (150). RACH configuration of serving cell 2 is obtained from system information of serving cell 2, which may be received by UE from serving cell 1.

According to an embodiment of FIG. 2, upon detecting serving cell 2, UE performs RACH (or random access) on serving cell 2 (or in other words initiates transmission of RRCResumeRequest if UE is in RRC_INACTIVE or initiates transmission of RRCSetup if UE is in RRC_IDLE), if serving cell 2 meets suitability criteria (for example, a cell is not barred, a cell belongs to registered public land mobile network (PLMN)/equivalent PLMN etc., or a cell quality is above threshold) or SSB measurement/cell quality for serving cell 2 is better than threshold, or if SSB /asurement/ cell quality of serving cell 2 is offset better than that of serving cell 1 (250, 270). Here, offset can be signaled by serving cell 1 or serving cell 2 in system information.

Otherwise (e.g., serving cell 2 does not meet suitability criteria, or SSB measurement/cell quality for serving cell 2 is not better than threshold, or if SSB measurement/cell quality of serving cell 2 is not offset better than that of serving cell 1), UE performs RACH (or random access) on serving cell 1 (or in other words initiates transmission of RRCResumeRequest if UE is in RRC_INACTIVE or initiates transmission of RRCSetup if UE is in RRC_IDLE) (250, 260). RACH configuration of serving cell 2 is obtained from system information of serving cell 2, which may be received by UE from serving cell 1. RACH configuration of serving cell 1 is obtained from system information of serving cell 1.

### Method 2

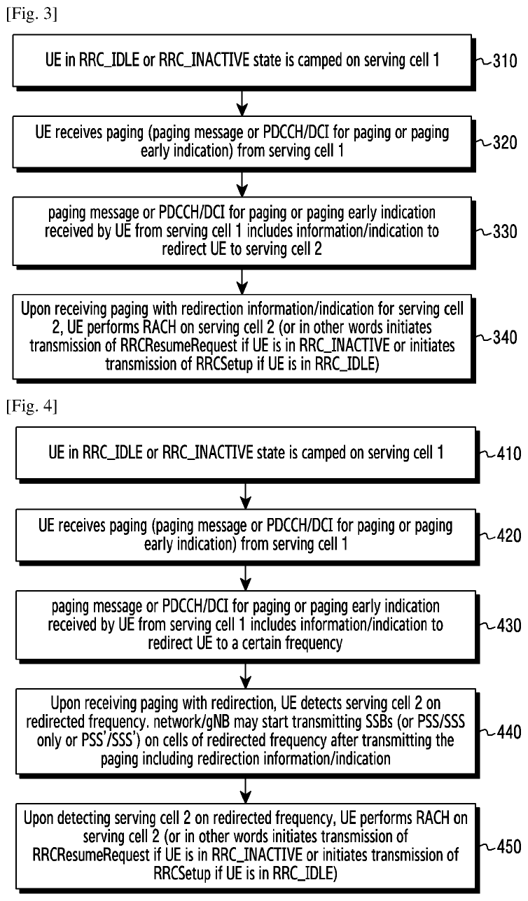

FIG. 3 illustrates another example of a RACH procedure in accordance with another embodiment of the disclosure.

Network comprise of serving cell (e.g., Cell 1) on a first carrier frequency F1 and another serving cell (e.g., Cell 2) on a second carrier frequency F2. Both serving cells are co-located (i.e., either they have same coverage or coverage of serving cell 1 can be larger than coverage of serving cell 2 wherein coverage of serving cell 2 is subset of coverage of serving cell 1).

Serving cell 2 does not broadcast system information. Serving cell 2 does not broadcast paging. Serving cell does not broadcast SSB. Serving cell 1 signals the system information for serving cell 2. Serving cell 1 may transmit one or more SIBs including system information for serving cell 2.

UE in RRC_IDLE or RRC_INACTIVE state is camped on serving cell 1 (310). UE receives paging (e.g., paging message or PDCCH/DCI for paging or paging early indication or low power wakeup signal/indication) from serving cell 1 (320). In an embodiment, paging message or PDCCH/DCI for paging or paging early indication received by UE from serving cell 1 includes information/indication to redirect UE to another cell (e.g., serving cell 2) (330). Information can be PCI of cell (e.g. PCI of Cell 2) or global cell identity of Cell 2 or cell index of Cell 2. Redirection information/indication in paging message can be per paging record included in paging message or it can be common for all paging records included in paging message. If Redirection information/indication in paging message is per paging record, UE considers redirection is for itself if it is included in paging record corresponding to UE's identity (5G-S-TMSI or I-RNTI). Redirection information/indication in paging early indication or low power wakeup signal/indication can be per (paging) subgroup or it can be common for all (paging) subgroups. UEs can be associated with different (paging) subgroup. If Redirection information/indication in paging early indication or low power wakeup signal/indication is per (paging) subgroup, UE considers redirection is for itself if it is included in paging early indication or low power wakeup signal/indication corresponding to UE's (paging) subgroup.

Upon receiving paging with redirection information/indication for serving cell 2, UE performs RACH (or random access) on serving cell 2 (or in other words initiates transmission of RRCResumeRequest if UE is in RRC_INACTIVE or initiates transmission of RRCSetup if UE is in RRC_IDLE) (340). RACH configuration of serving cell 2 is obtained from system information of serving cell 2, which may be received by UE from serving cell 1. UE assumes that DL timing of serving cell 2 is same as serving cell 1. In case there is any offset between the DL timing of serving cell 1 and serving cell 2, serving cell 1 can indicate the same in system information.

### Method 3

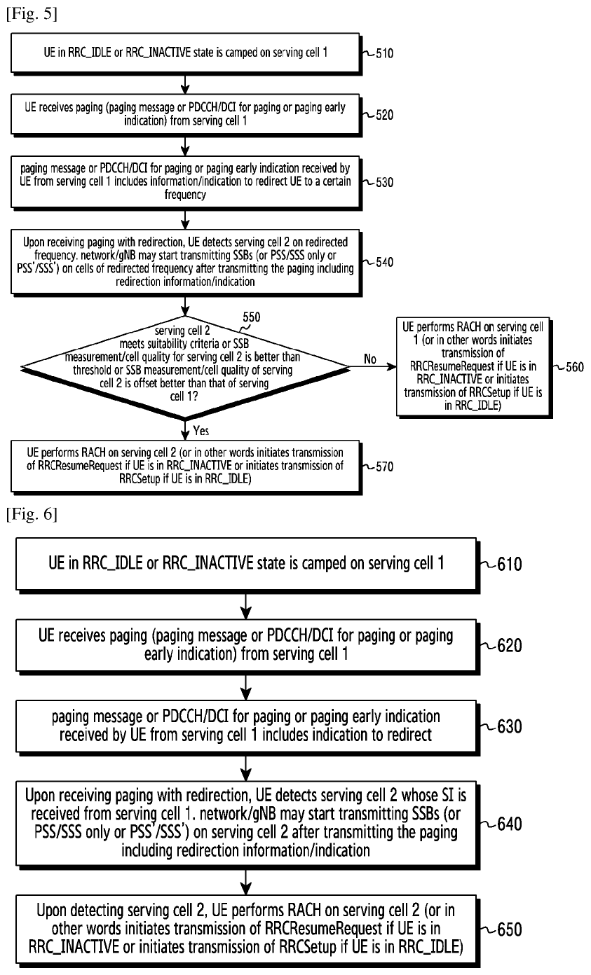

FIG. 4 and FIG. 5 illustrate examples of RACH procedure in accordance with embodiments of the disclosure.

Network comprise of serving cell (e.g., Cell 1) on a first carrier frequency F1 and another serving cell (e.g., Cell 2) on a second carrier frequency F2. Both serving cells are co-located (i.e., either they have same coverage or coverage of serving cell 1 can be larger than coverage of serving cell 2 wherein coverage of serving cell 2 is subset of coverage of serving cell 1).

Serving cell 2 does not broadcast system information. Serving cell 2 does not broadcast paging. Serving cell does not broadcast SSB. Serving cell 1 signals the system information for serving cell 2. Serving cell 1 may transmit one or more SIBs including system information for serving cell 2.

UE in RRC_IDLE or RRC_INACTIVE state is camped on serving cell 1 (410, 510). UE receives paging (paging message or PDCCH/DCI for paging or paging early indication or low power wakeup signal/indication) from serving cell 1 (420, 520). In an embodiment, paging message or PDCCH/DCI for paging or paging early indication or low power wakeup signal/indication received by UE from serving cell 1 includes information/indication to redirect UE to another cell (e.g., serving cell 2) (430, 530). Information can be carrier frequency (e.g., F2) or list of carrier frequencies. Redirection information/indication in paging message can be per paging record included in paging message or it can be common for all paging records included in paging message. If Redirection information/indication in paging message is per paging record, UE considers redirection is for itself if it is included in paging record corresponding to UE's identity (5G-S-TMSI or I-RNTI). Redirection information/indication in paging early indication or low power wakeup signal/indication can be per (paging) subgroup or it can be common for all (paging) subgroups. UEs can be associated with different (paging) subgroup. If Redirection information/indication in paging early indication or low power wakeup signal/indication is per (paging) subgroup, UE considers redirection is for itself if it is included in paging early indication or low power wakeup signal/indication corresponding to UE's (paging) subgroup.

Upon receiving paging with redirection, UE detects serving cell (e.g., serving cell 2 which may be the best cell on frequency) on redirected frequency (e.g., F2). In this method, network/gNB may start transmitting SSBs (or PSS/SSS only or PSS′/SSS′) on serving cells of redirected frequency(s) for certain time after transmitting the paging including redirection information/indication (440, 540).

According to an embodiment of FIG. 4, upon detecting serving cell 2 on redirected frequency, UE performs RACH (or random access) on serving cell 2 (or in other words initiates transmission of RRCResumeRequest if UE is in RRC_INACTIVE or initiates transmission of RRCSetup if UE is in RRC_IDLE) (450). RACH configuration of serving cell 2 is obtained from system information of serving cell 2, which may be received by UE from serving cell 1.

According to an embodiment of FIG. 5, upon detecting serving cell 2 on redirected frequency, UE performs RACH (or random access) on serving cell 2 (or in other words initiates transmission of RRCResumeRequest if UE is in RRC_INACTIVE or initiates transmission of RRCSetup if UE is in RRC_IDLE), if serving cell 2 meets suitability criteria or SSB measurement/cell quality for serving cell 2 is better than threshold, or if SSB measurement/cell quality of serving cell 2 is offset better than that of serving cell 1 (550, 570). Here, offset can be signaled by serving cell 1 or serving cell 2 in system information.

Otherwise (e.g., serving cell 2 does not meet suitability criteria, or SSB measurement/cell quality for serving cell 2 is not better than threshold, or if SSB measurement/cell quality of serving cell 2 is not offset better than that of serving cell 1), UE performs RACH (or random access) on serving cell 1 (or in other words initiates transmission of RRCResumeRequest if UE is in RRC_INACTIVE or initiates transmission of RRCSetup if UE is in RRC_IDLE) (550, 560). RACH configuration of serving cell 2 is obtained from system information of serving cell 2, which may be received by UE from serving cell 1. RACH configuration of serving cell 1 is obtained from system information of serving cell 1.

In an embodiment, if serving cell is not detected on redirected frequency(s), UE performs RACH (or random access) on serving cell 1 (or in other words initiates transmission of RRCResumeRequest if UE is in RRC_INACTIVE or initiates transmission of RRCSetup if UE is in RRC_IDLE).

### Method 4

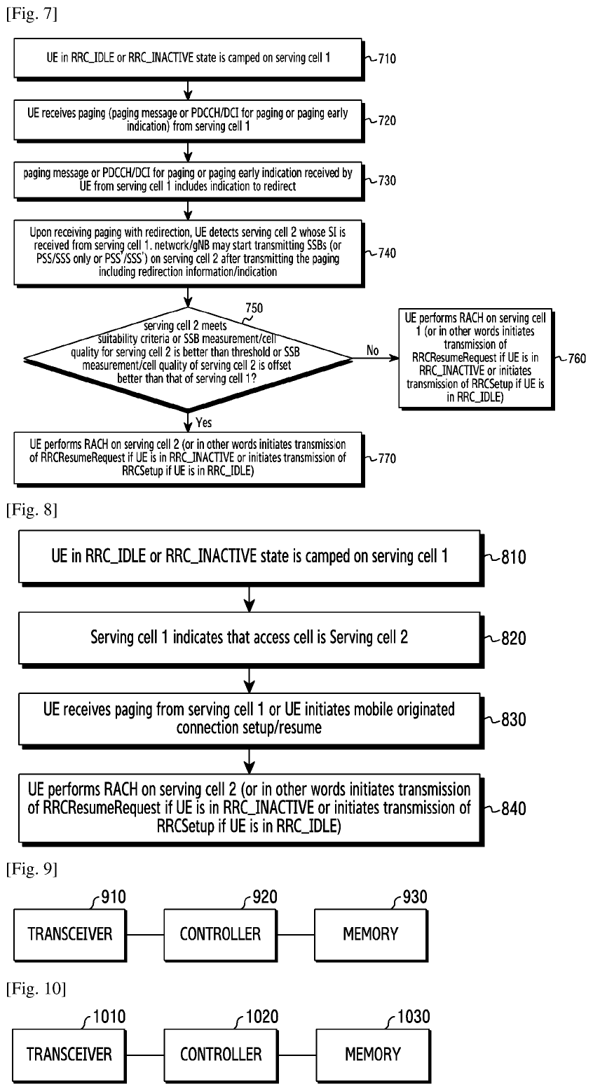

FIG. 6 and FIG. 7 illustrate examples of RACH procedure in accordance with embodiments of the disclosure.

Network comprise of serving cell (e.g., Cell 1) on a first carrier frequency F1 and another serving cell (e.g., Cell 2) on a second carrier frequency F2. Both serving cells are co-located (i.e., either they have same coverage or coverage of serving cell 1 can be larger than coverage of serving cell 2 wherein coverage of serving cell 2 is subset of coverage of serving cell 1).

Serving cell 2 does not broadcast system information. Serving cell 2 does not broadcast paging. Serving cell does not broadcast SSB. Serving cell 1 signals the system information for serving cell 2. Serving cell 1 may transmit one or more SIBs including system information for serving cell 2.

UE in RRC_IDLE or RRC_INACTIVE state is camped on serving cell 1 (610, 710). UE receives paging (paging message or PDCCH/DCI for paging or paging early indication or low power wakeup signal/indication) from serving cell 1 (620, 720). In an embodiment, paging message or PDCCH/DCI for paging or paging early indication or low power wakeup signal/indication received by UE from serving cell 1 includes redirection indication (630, 730). No redirection information e.g., carrier frequency or PCI is included. Redirection indication in paging message can be per paging record included in paging message or it can be common for all paging records included in paging message. If Redirection indication in paging message is per paging record, UE considers redirection is for itself if it is included in paging record corresponding to UE's identity (5G-S-TMSI or I-RNTI). Redirection information/indication in paging early indication or low power wakeup signal/indication can be per (paging) subgroup or it can be common for all (paging) subgroups. UEs can be associated with different (paging) subgroup. If Redirection information/indication in paging early indication or low power wakeup signal/indication is per (paging) subgroup, UE considers redirection is for itself if it is included in paging early indication or low power wakeup signal/indication corresponding to UE's (paging) subgroup.

Upon receiving paging with redirection, UE detects serving cell 2. Since UE has received system information for serving cell 2 from serving cell 1, it may try to detect serving cell 2 upon receiving paging message (or paging message with redirection indication). Note that in this option, network may start transmitting SSBs (or PSS/SSS only or PSS′/SSS′) on serving cell 2 for certain time after transmitting the paging (640, 740). In an alternate embodiment, serving cell to detect or carrier frequency for redirection upon receiving redirection indication can be signaled by serving cell in system information.

According to an embodiment of FIG. 6, upon detecting serving cell 2, UE performs RACH (or random access) on serving cell 2 (or in other words initiates transmission of RRCResumeRequest if UE is in RRC_INACTIVE or initiates transmission of RRCSetup if UE is in RRC_IDLE) (650). RACH configuration of serving cell 2 is obtained from system information of serving cell 2, which may be received by UE from serving cell 1.

According to an embodiment of FIG. 7, upon detecting serving cell 2, UE performs RACH (or random access) on serving cell 2 (or in other words initiates transmission of RRCResumeRequest if UE is in RRC_INACTIVE or initiates transmission of RRCSetup if UE is in RRC_IDLE), if serving cell 2 meets suitability criteria or SSB measurement/cell quality for serving cell 2 is better than threshold, or if SSB measurement/cell quality of serving cell 2 is offset better than that of serving cell 1 (750, 770). Here, offset can be signaled by serving cell 1 or serving cell 2 in system information.

Otherwise (e.g., serving cell 2 does not meet suitability criteria, or SSB measurement/cell quality for serving cell 2 is not better than threshold, or if SSB measurement/cell quality of serving cell 2 is not offset better than that of serving cell 1), UE performs RACH (or random access) on serving cell 1 (or in other words initiates transmission of RRCResumeRequest if UE is in RRC_INACTIVE or initiates transmission of RRCSetup if UE is in RRC_IDLE) (750, 760). RACH configuration of serving cell 2 is obtained from system information of serving cell 2, which may be received by UE from serving cell 1. RACH configuration of serving cell 1 is obtained from system information of serving cell 1.

### Method 5

FIG. 8 illustrates another example of a RACH procedure in accordance with another embodiment of the disclosure.

Network comprise of serving cell (e.g., Cell 1) on a first carrier frequency F1 and another serving cell (e.g., Cell 2) on a second carrier frequency F2. Both serving cells are co-located (i.e., either they have same coverage or coverage of serving cell 1 can be larger than coverage of serving cell 2 wherein coverage of serving cell 2 is subset of coverage of serving cell 1).

Serving cell 2 does not broadcast system information. Serving cell 2 does not broadcast paging. Serving cell does not broadcast SSB. Serving cell 1 signals the system information for serving cell 2. Serving cell 1 may transmit one or more SIBs including system information for serving cell 2.

UE in RRC_IDLE or RRC_INACTIVE state is camped on serving cell 1 (810). Serving cell 1 indicates that access cell is Serving cell 2 (820). UE receives paging from serving cell 1 or UE initiates mobile originated connection setup/resume (830).

UE performs RACH on serving cell 2 (or in other words initiates transmission of RRCResumeRequest if UE is in RRC_INACTIVE or initiates transmission of RRCSetup if UE is in RRC_IDLE) (840). RACH configuration of serving cell 2 is obtained from system information of serving cell 2, which may be received by UE from serving cell 1. Serving cell 1 indicates in SI that access cell for serving cell 1 is serving cell 2. UE assumes that DL timing of serving cell 2 is same as serving cell 1. In case there is any offset between the timing of serving cell 2 and serving cell 1, serving cell 1 can indicate the same in SI. In an embodiment, an indication for redirection can be there in paging.

### Method 6

Network comprise of serving cell (e.g., Cell 1) on a first carrier frequency F1 and another serving cell (e.g., Cell 2) on a second carrier frequency F2. Both serving cells are co-located (i.e., either they have same coverage or coverage of serving cell 1 can be larger than coverage of serving cell 2 wherein coverage of serving cell 2 is subset of coverage of serving cell 1).

Serving cell 2 does not broadcast system information. Serving cell 2 does not broadcast paging. Serving cell does not broadcast SSB. Serving cell 1 signals the system information for serving cell 2. Serving cell 1 may transmit one or more SIBs including system information for serving cell 2.

UE in RRC_IDLE or RRC_INACTIVE state is camped on serving cell 1. UE receives paging from serving cell 1 or UE initiates mobile originated connection setup/resume.

### Method 6-1

UE transmits RACH preamble to serving cell 1.

Serving cell 1 redirects the UE to serving cell 2 by redirection indication in RAR. In an embodiment, redirection indication can be included in MAC subheader of RAR MAC PDU or in payload of MAC subPDU of RAR MAC PDU. In an embodiment, a specific value of backoff indication can be used to indicate redirection.

UE stops the ongoing RACH (or random access procedure) on serving cell 1 and UE initiated random access procedure on serving cell 2.

Note that Redirection info and serving cell 2 selection can be done in similar as described in at least one of method 1 to method 5. PCI of serving cell 2 can be included in redirection indication, redirection frequency of serving cell 2 can be included in redirection indication, PCI or carrier frequency can be signaled by serving cell 1 in system information, serving cell 1 can indicate that access cell is serving cell 2.

### Method 6-2

UE transmits MsgA i.e., RACH preamble and MsgA MAC PDU to serving cell 1.

Serving cell 1 redirects the UE to serving cell 2 by redirection indication in MsgB. In an embodiment, redirection indication can be included in MAC subheader of MsgB MAC PDU or in payload of MAC subPDU of MsgB MAC PDU. In an embodiment, a specific value of backoff indication can be used to indicate redirection.

UE stops the ongoing RACH (or random access procedure) on serving cell 1 and UE initiated random access procedure on serving cell 2.

Note that Redirection info and serving cell 2 selection can be done in similar as described in at least one of method 1 to method 5. PCI of serving cell 2 can be included in redirection indication, redirection frequency of serving cell 2 can be included in redirection indication, PCI or carrier frequency can be signaled by serving cell 1 in system information, serving cell 1 can indicate that access cell is serving cell 2.

### Method 7—Cell DTX/DRX Aspects

Cell discontinuous transmission and discontinuous reception (DTX/DRX) is applied to at least UEs in RRC_CONNECTED state. A periodic Cell DTX/DRX (i.e., active and non-active periods) can be configured by gNB via RRC signaling. One of the following operations can be performed at gNB/UE during the Cell DTX/DRX non-active periods.
Option 7-1: GNB turns off all transmission and reception for data traffic and reference signal during Cell DTX/DRX non-active periods. In other words, gNB turns off all transmission on physical layer channels such as PDCCH, PDSCH, turns off all reception on physical layer channels such as PUSCH, PUCCH and PRACH, turns of transmission of reference signals such as DM-RS, turns off reception of reference signals such as SRS etc. of the cell. GNB may also turnoff transmission of PBCH and SSB of the cell.

UE turns off all reception on physical layer channels such as PDCCH, PDSCH, turns off all transmission on physical layer channels such as PUSCH, PUCCH and PRACH, turns off reception of reference signals such as DM-RS, turns off transmission of reference signals such as SRS etc. of the cell.
Option 7-2: gNB turns off its transmission/reception only for data traffic during Cell DTX/DRX non-active periods (i.e., gNB will still transmit/receive reference signals). In other words, gNB turns off all transmission on physical layer channels such as PDCCH, PDSCH, turns off all reception on physical layer channels such as PUSCH, PUCCH and PRACH, continues transmission of reference signals such as DM-RS, continues reception of reference signals such as SRS etc. of the cell. GNB may or may not continue transmission of transmission of PBCH and SSB of the cell.

UE turns off all reception on physical layer channels such as PDCCH, PDSCH, turns off all transmission on physical layer channels such as PUSCH, PUCCH and PRACH, continues reception of reference signals such as DM-RS, continues transmission of reference signals such as SRS etc. of the cell.
Option 7-3: gNB turns off its dynamic data transmission/reception during Cell DTX/DRX non-active periods (i.e., gNB still perform transmission/reception in periodic resources, including semi-persistent scheduling (SPS), configured grant (CG)-PUSCH, scheduling request (SR), RACH, and SRS). UE turns off its dynamic data transmission/reception during Cell DTX/DRX non-active periods (i.e., UE still perform transmission/reception in periodic resources, including SPS, CG-PUSCH, SR, RACH, and SRS).
Option 7-4: gNB only transmit reference signals (e.g., CSI-RS for measurement). UE only receive reference signals (e.g., CSI-RS for measurement).

In an embodiment which one of the options is applied during DTX/DRX non-active periods of cell is indicated by gNB to UE using MAC CE or DCI or RRC message. In an embodiment, a list of options is signaled by gNB to UE via RRC message and one of the options to be applied for during DTX/DRX non-active periods of cell is signaled by GNB to UE using MAC CE or DCI. In an embodiment, a list of options is signaled by gNB to UE via MAC CE and one of the options to be applied for during DTX/DRX non-active periods of cell is signaled by GNB to UE using DCI. The PDCCH of DCI can be addressed to C-RNTI or group RNTI common for multiple UEs or common for entire cell. The option to be applied can be indicated per BWP or per Cell or per CG.

### Method 8—Cell Barring Aspects

Method 8-1: In this method it is assumed that UE is not a reduced capability (RedCap) UE.

In an embodiment, if cellBarred in MIB is set to ‘barred’ both UEs supporting and not supporting NES will bar the cell for a pre-defined time. If intraFrequencyReselection field in MIB is set to allowed, UE does not bar the frequency of barred cell. If intraFrequency Reselection field in MIB is set to not allowed, UE bar the frequency of barred cell.

In an embodiment, if cellBarred in MIB is set to ‘not barred’, UE not supporting NES will not bar the cell. UE supporting NES acquires SIB1 and perform the following:
If cellBarred-NES in SIB1 is present and is set to ‘barred’, UE supporting NES perform the following operation:
   UE supporting NES bars the cell. UE may bar the cell for a pre-defined time.
   In an embodiment, if intraFrequencyReselection field in MIB is set to allowed, UE does not bar the frequency of barred cell. If intraFrequencyReselection field in MIB is set to not allowed, UE bar the frequency of barred cell.
   In an alternate embodiment, UE does not bar the frequency irrespective of whether intraFrequencyReselection field in MIB is set to not allowed or allowed.
   In an alternate embodiment, intraFrequencyReselection-NES can be included in SIB1. If intraFrequencyReselection-NES field in SIB1 is set to allowed, UE does not bar the frequency of barred cell. If intraFrequencyReselection-NES field in SIB1 is set to not allowed, UE bar the frequency of barred cell
If cellBarred-NES in SIB1 is present and is set to ‘not barred’:
   UE does not bar the cell.
Method 8-2: In this method it is assumed that UE is a RedCap UE.

In an embodiment, if cellBarredRedcap in SIB1 is set to ‘barred’ both UEs supporting and not supporting NES will bar the cell for a pre-defined time. If intraFrequencyReselectionRedcap field in SIB1 is set to allowed, UE does not bar the frequency of barred cell. If intraFrequencyReselectionRedcap field in SIB1 is set to not allowed, UE bar the frequency of barred cell.

In an embodiment, if cellBarredRedcap in SIB1 is set to ‘not barred’, UE not supporting NES will not bar the cell. UE supporting NES perform the following:
If cellBarred-NES in SIB1 is present and is set to ‘barred’, UE supporting NES perform the following operation:
   UE supporting NES bars the cell. UE may bar the cell for a pre-defined time.
   In an embodiment, if intraFrequencyReselectionRedcap field in SIB1 is set to allowed, UE does not bar the frequency of barred cell. If intraFrequencyReselectionRedcap field in SIB1 is set to not allowed, UE bar the frequency of barred cell.
   In an alternate embodiment, UE does not bar the frequency irrespective of whether intraFrequencyReselectionRedcap field in SIB1 is set to not allowed or allowed.
   In an alternate embodiment, intraFrequencyReselection-NES can be included in SIB1. If intraFrequencyReselection-NES field in SIB1 is set to allowed, UE does not bar the frequency of barred cell. If intraFrequencyReselection-NES field in SIB1 is set to not allowed, UE bar the frequency of barred cell
   In an embodiment, if intraFrequencyReselection field in MIB is set to allowed, UE does not bar the frequency of barred cell. If intraFrequencyReselection field in MIB is set to not allowed, UE bar the frequency of barred cell.
If cellBarred-NES in SIB1 is present and is set to ‘not barred’:
   UE does not bar the cell.
Method 8-3: In this method it is assumed that UE is not a RedCap UE.

UE supporting NES acquires MIB from cell. It acquires SIB1 irrespective of whether cellBarred field in MIB is set to barred or not barred.

If UE supports NES and cellBarred-NES in SIB1 is present and is set to ‘barred’:
UE bars the cell. UE may bar the cell for a pre-defined time.
In an embodiment, if intraFrequencyReselection field in MIB is set to allowed, UE does not bar the frequency of barred cell. If intraFrequencyReselection field in MIB is set to not allowed, UE bar the frequency of barred cell.
In an alternate embodiment, UE does not bar the frequency irrespective of whether intraFrequencyReselection field in MIB is set to not allowed or allowed.
In an alternate embodiment, intraFrequencyReselection-NES can be included in SIB1. If intraFrequency Reselection-NES field in SIB1 is set to allowed, UE does not bar the frequency of barred cell. If intraFrequencyReselection-NES field in SIB1 is set to not allowed, UE bar the frequency of barred cell

If UE supports NES and cellBarred-NES in SIB1 is present and is set to ‘not barred’:
UE does not bar the cell.

If UE supports NES and cellBarred-NES in SIB1 is not present:
UE performs barring based on cellBarred field in MIB. If cellBarred field is set to barred, UE bars the cell for a pre-defined time. If cellBarred field is set to not barred, UE does not bar the cell. In case of baring the cell, UE bars the frequency if intraFrequencyReselection field in MIB is set to not allowed and does not bar the frequency if intraFrequency Reselection field in MIB is set to allowed
Method 8-4: In this method it is assumed that UE is a RedCap UE.

If UE supports NES and cellBarred-NES in SIB1 is present and is set to ‘barred’:
UE bars the cell. UE may bar the cell for a pre-defined time.
In an embodiment, if intraFrequencyReselection field in MIB is set to allowed, UE does not bar the frequency of barred cell. If intraFrequencyReselection field in MIB is set to not allowed, UE bar the frequency of barred cell.
In an alternate embodiment, UE does not bar the frequency irrespective of whether intraFrequencyReselection field in MIB is set to not allowed or allowed.
In an alternate embodiment, intraFrequencyReselection-NES can be included in SIB1. If intraFrequencyReselection-NES field in SIB1 is set to allowed, UE does not bar the frequency of barred cell. If intraFrequencyReselection-NES field in SIB1 is set to not allowed, UE bar the frequency of barred cell

If UE supports NES and cellBarred-NES in SIB1 is present and is set to ‘not barred’:
UE does not bar the cell.

If UE supports NES and cellBarred-NES in SIB1 is not present:
UE performs barring based on cellBarredRedcap (1RX or 2 RX) field in SIB1. If cellBarredRedcap (1RX or 2 RX) field is set to barred, UE (1RX or 2RX) bars the cell for a pre-defined time. If cellBarredRedcap (1RX or 2 RX) field is set to not barred, UE (1RX or 2RX) does not bar the cell. In case of baring the cell, UE bars the frequency if intraFrequencyReselectionRedcap field in SIB1 is set to not allowed and does not bar the frequency if intraFrequencyReselectionRedcap field in SIB1 is set to allowed

FIG. 9 is a block diagram of a terminal according to an embodiment of the disclosure.

Referring to FIG. 9, a terminal includes a transceiver 910, a controller 920 and a memory 930. The controller 920 may refer to a circuitry, an application-specific integrated circuit (ASIC), or at least one processor. The transceiver 910, the controller 920 and the memory 930 are configured to perform the operations of the UE illustrated in the figures, e.g., FIGS. 1 to 8, or described above. Although the transceiver 910, the controller 920 and the memory 930 are shown as separate entities, they may be realized as a single entity like a single chip. Or, the transceiver 910, the controller 920 and the memory 930 may be electrically connected to or coupled with each other.

The transceiver 910 may transmit and receive signals to and from other network entities (e.g., a base station or another terminal).

The controller 920 may control the UE to perform functions according to one of the embodiments described above.

In an embodiment, the operations of the terminal may be implemented using the memory 930 storing corresponding program codes. Specifically, the terminal may be equipped with the memory 930 to store program codes implementing desired operations. To perform the desired operations, the controller 920 may read and execute the program codes stored in the memory 930 by using a processor or a central processing unit (CPU).

FIG. 10 is a block diagram of a base station according to an embodiment of the disclosure.

Referring to FIG. 10, a base station includes a transceiver 1010, a controller 1020 and a memory 1030. The transceiver 1010, the controller 1020 and the memory 1030 are configured to perform the operations of the base station illustrated in the figures, e.g., FIGS. 1 to 8, or described above. Although the transceiver 1010, the controller 1020 and the memory 1030 are shown as separate entities, they may be realized as a single entity like a single chip. The transceiver 1010, the controller 1020 and the memory 1030 may be electrically connected to or coupled with each other.

The transceiver 1010 may transmit and receive signals to and from other network entities, e.g., a terminal. The controller 1020 may control the base station to perform functions according to one of the embodiments described above. The controller 1020 may refer to a circuitry, an ASIC, or at least one processor. In an embodiment, the operations of the base station may be implemented using the memory 1030 storing corresponding program codes. Specifically, the base station may be equipped with the memory 1030 to store program codes implementing desired operations. To perform the desired operations, the controller 1020 may read and execute the program codes stored in the memory 1030 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1. A method performed by a terminal in a wireless communication system, the method comprising:
receiving, on a first cell of a first frequency, redirect information associated with a second cell of a second frequency; and
performing a random access procedure on the second cell of the second frequency based on the redirect information.

2. The method of claim 1, wherein the random access procedure is performed on the second cell, in case that a criteria for the second cell is met or a measurement for the second cell is better than a threshold.

3. The method of claim 2, further comprising:
performing a random access procedure on the first cell of the first frequency, in case that the criteria is not met and the measurement is not better than the threshold.

4. The method of claim 1, further comprising:
receiving, on the second cell of the second frequency, a synchronization signal based on the redirect information.

5. The method of claim 1, wherein a downlink timing of the second cell is same as a downlink timing of the first cell, or
wherein an offset between the downlink timing of the second cell and the downlink timing of the first cell is indicated in system information of the first cell.

6. The method of claim 1, wherein the redirect information is included in a paging message from the first cell or a random access response from the first cell.

7. The method of claim 1, wherein the redirect information includes at least one of a physical cell identity of the second cell or a carrier frequency of the second cell.

8. The method of claim 1, wherein the redirect information includes an indication for redirection, and
wherein the second cell is detected by the terminal based on the indication.

9. A terminal in a wireless communication system, the terminal comprising:
a transceiver; and
a controller coupled with the transceiver and configured to:
receive, on a first cell of a first frequency, redirect information associated with a second cell of a second frequency, and
perform a random access procedure on the second cell of the second frequency based on the redirect information.

10. The terminal of claim 9, wherein the random access procedure is performed on the second cell, in case that a criteria for the second cell is met or a measurement for the second cell is better than a threshold.

11. The terminal of claim 10, wherein the controller is further configured to:
perform a random access procedure on the first cell of the first frequency, in case that the criteria is not met and the measurement is not better than the threshold.

12. The terminal of claim 9, wherein the controller is further configured to:
receiving, on the second cell of the second frequency, a synchronization signal based on the redirect information.

13. The terminal of claim 9, wherein a downlink timing of the second cell is same as a downlink timing of the first cell, or
wherein an offset between the downlink timing of the second cell and the downlink timing of the first cell is indicated in system information of the first cell.

14. The terminal of claim 9, wherein the redirect information is included in a paging message from the first cell or a random access response from the first cell, and
wherein the redirect information includes at least one of a physical cell identity of the second cell or a carrier frequency of the second cell.

15. The terminal of claim 9, wherein the redirect information includes an indication for redirection, and
wherein the second cell is detected by the terminal based on the indication.
